(19) United States
(12) Patent Application Publication
(10) Pub. No.: US 2006/0030513 A1
(43) Pub. Date: Feb. 9, 2006

(54) Softening laundry detergent

(75) Inventors: David Alan Binder, Saddle Brook, NJ (US); Dennis Stephen Murphy, Wyckoff, NJ (US); Michael Orchowski, East Rutherford, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division Of Conopco, Inc.

(21) Appl. No.: 10/910,737

(22) Filed: Aug. 3, 2004

(51) Int. Cl. C11D 3/00

(52) U.S. Cl. 510/515

(57) ABSTRACT

The present invention is directed to laundry compositions which deliver both effective softening and effective cleaning, containing: (a) a cationic polymer having a weight average molecular weight of less than about 850,000 daltons; (b) about 1% to about 60% of a nonionic oil; and (c) at least about 5% of anionic surfactant, wherein the ratio of said cationic polymer to said nonionic oil is less than about 0.25; wherein the ratio of cationic monomeric surfactant to said nonionic oil is less than about 0.2; and having a Softening Parameter of greater than about 70. A method of conditioning articles using the inventive compositions is also disclosed.

### FIELD OF THE INVENTION

This invention relates to laundry conditioning compositions. More particularly, the invention is directed to softening laundry detergent compositions.

### BACKGROUND OF THE INVENTION

Traditionally, textile fabrics, including clothes, have been cleaned with laundry detergents, which provide excellent soil removal, but can often make garments feel harsh after washing. To combat this problem, a number of fabric conditioning technologies, including rinse-added softeners, dryer sheets, and 2-in-1 detergent softeners, have been developed. 2-in-1 detergent softeners have normally been the most convenient of these technologies for consumers, but many of these existing technologies still have disadvantages.

Softening laundry detergent compositions have been disclosed in U.S. Pat. Nos. 6,616,705; 6,620,209; 4,844,821; and Caswell et al. U.S. Pat. Nos. 5,073,274 and 4,913,828. Hsu, U.S. Pat. No. 6,369,018 discloses the use of cationic cellulose ether (polymer JR) in an anionic surfactant containing liquid detergent and further requires a polysaccharide polymer such as xanthan gum. Kishkel, U.S. 2002/055451 relates to a detergent tablet with soap, which also softens (cationic polymer as softening agent). Kishkel U.S. Pat. No. 6,616,705 (Cognis) relates to detergent softener formulations containing high amounts of cationic polymers, anionic surfactants, phosphates and optionally layered silicates. Zhen, WO 97/31998 (P&G) relates to detergent-softener compositions comprising cationic (monomeric) surfactants and silicone emulsions, along with anionic detersive surfactants.

Fabric softener compositions have been disclosed in U.S. Pat. No. 6,492,322. Grainger, WO 98/16538 (Unilever) discloses fabric conditioners comprising oily sugar derivatives, i.e., sucrose polyesters, in conjunction with a deposition aid. The deposition aid may be, for example, a cationic surfactant, a cationic polymer or a nonionic surfactant. Grainger, WO 01/46359 discloses fabric softening compositions based on oily sugar derivatives derived from oleyl and tallow feedstocks and deposition aids. Cationic polymers and anionic surfactants are mentioned among the listed suitable deposition aids. Grainger et al., U.S. Pat. No. 6,727,220 (equivalent of WO 00/70005) relates to fabric softening compositions containing a nonionic fabric softening agent, an anionic surfactant, a cationic, polymer, with no more than 1% by weight of non-polymeric cationic surfactant and/or cationic fabric softening compounds. Ellson, WO 01/46513 (Unilever) discloses the use of fabric conditioning compositions comprising oily sugar derivatives and deposition aids (including cationic polymers) for gaining ironing benefits. Such formulations comprising cationic polymers are “preferably” wash cycle compositions. The disclosed compositions may comprise 0.1-10% anionics, preferably 0.5%-3.5%. Provides examples of wash-cycle softeners comprising 20% STP, 3% cationic surfactant, 18% nonionic, 15% oily sugar derivative and either 0.1% or 1% cationic polymer.

Jones, WO 01/07546 (Unilever) discloses fabric conditioner concentrates comprising less than 30% water, which comprise an oily sugar derivative, an emulsifier and a deposition aid. The deposition aid may be a cationic polymer, a cationic surfactant or other, with cationic polymers preferred.

Grainger, WO 00/70004 (Unilever) relates to fabric conditioners comprising at least partially unsaturated oily sugar derivatives in conjunction with a deposition aid and an antioxidant. The deposition aid may be, for example, a cationic surfactant, an anionic surfactant, a cationic polymer or a nonionic surfactant.

Furuya WO 95/00614 (Kao) relates rinse conditioners comprising polyhydric alcohol esters and cationic cellulose polymers, in a ratio of polymer:ester of 0.01 to 0.5. The use of nonionic surfactants, such as alcohol ethoxylates, to improve the dispersibility of the composition is also suggested.

Dekker, EP 0 220 156 (P&G) Details fabric conditioning compositions containing cyclic amine softening agents, quaternary ammonium salts, a soil release agent and optionally a silicone component. Among the soil release agents suggested are cationic polymers such as Polymer JR 30M. The pH of these compositions is typically less than 6, and they are normally emulsions. Furthermore, no mention is made of detergent properties.

Schymitzek U.S. 2003/0162689 (Cognis) Describes liquid rinse conditoners formulated to reduce pill formation on fabrics. Among the pill-reducing agents are nonionic polymers, including modified celluloses, cationic polymers, including Polymer JR, and silicone oils. A substantial fraction of the active material in the designated examples is monomeric quat, rendering these formulations.

Grimm U.S. 2002/015593 (P&G) discloses fabric softeners based on tertiary amine actives, where cationic polymers are used as additives to increase charge density. Silicone oils are mentioned as potential softness enhancers.

Rudkin, U.S. Pat. No. 4,179,382 (P&G) Covers the use of textile conditioning compositions comprising a cationic surfactant-type conditioning agent, a small quantity of a cationic polymer and optionally a small amount of nonionic adjuviant, present in a ratio of cationic material:nonionic agent of greater than 10:1. This patent does not suggest that such systems may be capable of softening through the wash, requires a large amount of cationic monomeric quat, and requires a very high ratio of cationic material:nonionic material, which would be good to avoid.

Cationic polymers in combination with soap and other anionic surfactants are broadly described and claimed in Applicants' co-pending patent application Ser. Nos. 10/446,202 filed May 27, 2003 and 10/727,234 filed Dec. 3, 2003.

A need remains for softening laundry detergent compositions including cationic polymers for improved softening achieved through adding the compositions in the wash cycle of automatic washing machines, without compromising cleaning performance.

### SUMMARY OF THE INVENTION

A softening laundry detergent composition including:
(a) a cationic polymer having a weight average molecular weight of less than about 850,000 daltons;
(b) about 1% to about 60% of a nonionic oil; and
(c) at least about 5% of a surfactant selected from the group consisting of anionic surfactant, cationic monomeric surfactant, nonionic surfactant, zwiterionic surfactant, and combinations thereof;
wherein the ratio of said cationic polymer to said nonionic oil is less than about 0.25;
wherein the ratio of the cationic monomeric surfactant to the nonionic oil is less than about 0.2; and
having a Softening Parameter of greater than about 70.
   More preferably, the Softening Parameter is greater than about 80, for maximum softening at the same cleaning capacity.

In another aspect, this invention is directed to a method for conditioning textiles comprising, in no particular order, the steps of:
a. providing a laundry detergent or fabric softener composition comprising anionic surfactant, nonionic oil cationic polymer, in ratios and concentration to effectively soften and condition fabrics under predetermined laundering conditions;
b. contacting one or more articles with the composition at one or more points during a laundering process; and
c. allowing the articles to dry or mechanically tumble-drying them.

The concentration of cationic polymer will generally be less than about 3% of the total product mass. Cationic polymers include dimethyl diallyl ammonium chloride/acrylamide copolymer, dimethyl diallyl ammonium chloride/acrylic acid/acrylamide terpolymer, vinylpyrrolidone/methyl vinyl imidazolium chloride copolymer, polydimethyl diallyl ammonium chloride, starch hydroxypropyl trimmonium chloride, polymethacryl amidopropyl trimethyl ammonium chloride, acrylamidopropyl trimmonium chloride/acrylamide copolymer, guar hydroxypropyl trimonium chloride, hydroxyethyl cellulose derivatized with trimethyl ammonium substituted epoxide, and mixtures thereof.

### DETAILED DESCRIPTION OF THE INVENTION

The present invention is directed to laundry compositions which deliver both effective softening and effective cleaning, containing:
(a) a cationic polymer having a weight average molecular weight of less than about 850,000 daltons;
(b) about 1% to about 60% of a nonionic oil; and
(c) at least about 5% of a surfactant selected from the group consisting of anionic surfactant, cationic monomeric surfactant, nonionic surfactant, zwiterionic surfactant, and combinations thereof;
wherein the ratio of said cationic polymer to said nonionic oil is less than about 0.25;
wherein the ratio of cationic monomeric surfactant to said nonionic oil is less than about 0.2; and
having a Softening Parameter of greater than about 70.

The present invention is based on the surprising finding that cationic polymers can be used in laundry detergent formulations that, in addition to comprising cationic polymers, anionic and/or nonionic surfactants, also contain one or more nonionic oils. Preferably, these compositions comprise one or more cleaning enhancers, such as optical brighteners, enzymes or antiredepositon polymers.

The cationic polymers of this invention can be any cationic polyelectrolye; examples of suitable materials include cationically-modified polysaccharides such as Polyquaternium-10, fully synthetic cationic polymers such as polyquaternium-7 and cationic silicones, such as the ABIL QUAT series available from Degussa. These materials are intended to serve primarily as deposition aids, as opposed to fabric softening agents, and accordingly should be present at a low concentration relative to the nonionic oil and anionic/nonionic surfactants used to formulate the composition.

The nonionic oils used in this invention are typically either entirely nonpolar, or very slightly polar, having an HLB of less than about 15. They can exist as either liquids or soft solids in the neat state, but preferably these materials have an HLB of less than about 8. Examples of suitable nonpolar oils include the esters and ethers of cyclic polyols and reduced saccharides described in WO 98/16538, along with silicone oils, mineral oils and the like.

We further prefer that the level of cationic, monomeric surfactant (defined as amphiphilic molecules with a net positive charge and a molecular weight between 50 and 1,000) be limited. This is because such materials tend to interfere with both the cleaning performance of anionic surfactants, and can negatively impact product stability in the case of a liquid detergent-softener. In the preferred case, the compositions of this invention comprise less than 5% cationic monomeric surfactant; in a more desired case, these materials are present at a level less than 3%, and in the most preferred case, these materials are included at a level less than 1.5%.

Surprisingly, these compositions provide a substantial softening benefit when dosed to the wash cycle, as opposed the final rinse. Without wishing to be bound by theory, it is believed that the cationic polymers of this invention bind strongly to the fabric surface, significantly more so than do the monomeric quaternaries found in traditional fabric softeners. Also, raising the pH of the product (or, in the case of a solid detergent composition, the pH of the wash liquor when product is dissolved at the recommended use rate), to a level above about 5, can yield a substantial improvement in cleaning performance. In addition, it has been found that these products clean substantially better when the total surfactant concentration (defined as amphiphilic nonionic or anionic materials with an HLB greater than about 8) is at or above the level of nonpolar oil, and at a lever higher than about 6%. The anionic and nonionic materials should have a molecular weight of less than about 10,000 Daltons. It is also desirable that the level of anionic surfactant be above 3%, and more preferably above 6%. In addition, these compositions should contain less than about 10% phosphate, in order to minimize their environmental impact.

These laundry detergent-softeners can be marketed in any form known to those skilled in the art. Examples of suitable such forms include isotropic liquids, structured liquids, powders, sachets, tablets and soluble sheets.

In a preferred embodiment, the Softening Parameter is greater than about 80, for maximum softening at a given cleaning capacity.

As used herein, the term “comprising” means including, made up of, composed of, consisting and/or consisting essentially of. Furthermore, in the ordinary meaning of “comprising,” the term is defined as not being exhaustive of the steps, components, ingredients, or features to which it refers.

As used herein, the term “substantially free of precipitation” means that insoluble and substantially insoluble matter will be limited to less than about 10% of the composition, more preferably to about 5% or less.

Except in the operating and comparative examples, or where otherwise explicitly indicated, all numbers in this description indicating amounts or ratios of material or conditions of reaction, physical properties of materials and/or use are to be understood as modified by the word “about”.

Surfactant

### Anionic Surfactant

In order to attain the desired level of softening, with a Softening Parameter of greater than about 70, the inventive softening laundry compositions contain greater than about 5% anionic surfactant by weight of the composition.

The anionic surfactants used in this invention can be any anionic surfactant that is water soluble. “Water soluble” surfactants are, unless otherwise noted, here defined to include surfactants which are soluble or dispersible to at least the extent of 0.01% by weight in distilled water at 25° C. “Anionic surfactants” are defined herein as amphiphilic molecules with an average molecular weight of less than about 10,000, comprising one or more functional groups that exhibit a net anionic charge when in aqueous solution at the normal wash pH of between 6 and 11. It is preferred that at least one of the anionic surfactants used in this invention be an alkali or alkaline earth metal salt of a natural or synthetic fatty acid containing between 4 and 30 carbon atoms. It is especially preferred to use a mixture of carboxylic acid salts with one or more other anionic surfactants. Another important class of anionic compounds are the water soluble salts, particularly the alkali metal salts, of organic sulfur reaction products having in their molecular structure an alkyl radical containing from about 6 to 24 carbon atoms and a radical selected from the group consisting of sulfonic and sulfuric acid ester radicals.

Carboxylic Acid Salts
R¹COOM
where R¹ is a primary or secondary alkyl group of 4 to 30 carbon atoms and M is a solubilizing cation. The alkyl group represented by R¹ may represent a mixture of chain lengths and may be saturated or unsaturated, although it is preferred that at least two thirds of the R¹ groups have a chain length of between 8 and 18 carbon atoms. Nonlimiting examples of suitable alkyl group sources include the fatty acids derived from coconut oil, tallow, tall oil and palm kernel oil. For the purposes of minimizing odor, however, it is often desirable to use primarily saturated carboxylic acids. Such materials are available from many commercial sources, such as Uniqema (Wilmington, Del.) and Twin Rivers Technologies (Quincy, Mass.). The solubilizing cation, M, may be any cation that confers water solubility to the product; although monovalent moieties are generally preferred. Examples of acceptable solubilizing cations for use with this invention include alkali metals such as sodium and potassium, which are particularly preferred, and amines such as triethanolammonium, ammonium and morpholinium. Although, when used, the majority of the fatty acid should be incorporated into the formulation in neutralized salt form, it is often preferable to leave a small amount of free fatty acid in the formulation, as this can aid in the maintenance of product viscosity.
   Primary Alkyl Sulfates
   R²OSO₃M
   where R² is a primary alkyl group of 8 to 18 carbon atoms and M is a solubilizing cation. The alkyl group R² may have a mixture of chain lengths. It is preferred that at least two-thirds of the R²alkyl groups have a chain length of 8 to 14 carbon atoms. This will be the case if R² is coconut alkyl, for example. The solubilizing cation may be a range of cations which are in general monovalent and confer water solubility. An alkali metal, notably sodium, is especially envisaged. Other possibilities are ammonium and substituted ammonium ions, such as trialkanolammonium or trialkylammonium.
   Alkyl Ether Sulfates
   R³O(CH₂CH₂O)ₙSO₃M
   where R³ is a primary alkyl group of 8 to 18 carbon atoms, n has an average value in the range from 1 to 6 and M is a solubilizing cation. The alkyl group R³ may have a mixture of chain lengths. It is preferred that at least two-thirds of the R³ alkyl groups have a chain length of 8 to 14 carbon atoms. This will be the case if R³ is coconut alkyl, for example. Preferably n has an average value of 2 to 5. Ether sulfates have been found to provide viscosity build in certain of the formulations of this invention, and thus are considered a preferred ingredient.
   Fatty Acid Ester Sulfonates
   R⁴CH(SO₃M)CO₂R⁵
   where R⁴ is an alkyl group of 6 to 16 atoms, R⁵ is an alkyl group of 1 to 4 carbon atoms and M is a solubilizing cation. The group R⁴ may have a mixture of chain lengths. Preferably at least two-thirds of these groups have 6 to 12 carbon atoms. This will be the case when the moiety R⁸CH(−)CO₂(−) is derived from a coconut source, for instance. It is preferred that R⁵ is a straight chain alkyl, notably methyl or ethyl.
   Alkyl Benzene Sulfonates
   R⁶ArSO₃M
   where R⁶ is an alkyl group of 8 to 18 carbon atoms, Ar is a benzene ring (C₆H₄) and M is a solubilizing cation. The group R⁶ may be a mixture of chain lengths. A mixture of isomers is typically used, and a number of different grades, such as “high 2-phenyl” and “low 2-phenyl” are commercially available for use depending on formulation needs. A plentitude of commercial suppliers exist for these materials, including Stepan (Northfield, Ill.) and Witco (Greenwich, Conn.) Typically they are produced by the sulfonation of alkylbenzenes, which can be produced by either the HF-catalyzed alkylation of benzene with olefins or an AlCl₃-catalyzed process that alkylates benzene with chloroparaffins, and are sold by, for example, Petresa (Chicago, Ill.) and Sasol (Austin, Tex.). Straight chains of 11 to 14 carbon atoms are usually preferred.

Paraffin sulfonates having 8 to 22 carbon atoms, preferably 12 to 16 carbon atoms, in the alkyl moiety. They are usually produced by the sulfoxidation of petrochemically-derived normal paraffins. These surfactants are commercially available as, for example, Hostapur SAS from Clariant (Charlotte, N.C.).

Olefin sulfonates having 8 to 22 carbon atoms, preferably 12 to 16 carbon atoms. U.S. Pat. No. 3,332,880 contains a description of suitable olefin sulfonates. Such materials are sold as, for example, Bio-Terge AS-40, which can be purchased from Stepan (Northfield, Ill.)

Sulfosuccinate Esters
R⁷OOCCH₂CH(SO₃⁻M⁺)COOR⁸
are also useful in the context of this invention. R⁷ and R⁸ are alkyl groups with chain lengths of between 2 and 16 carbons, and may be linear or branched, saturated or unsaturated. A preferred sulfosuccinate is sodium bis (2-ethylhexyl) sulfosuccinate, which is commercially available under the tradename Aerosol OT from Cytec Industries (West Paterson, N.J.).

Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Also included are nonionic alkoxylates having a sodium alkylenecarboxylate moiety linked to a terminal hydroxyl group of the nonionic through an ether bond. Counterions to the salts of all the foregoing may be those of alkali metal, alkaline earth metal, ammonium, alkanolammonium and alkylammonium types.

Other preferred anionic surfactants include the fatty acid ester sulfonates with formula:
R⁹CH(SO₃M) CO₂R¹⁰
where the moiety R⁹CH(−)CO₂(−) is derived from a coconut source and R¹⁰ is either methyl or ethyl; primary alkyl sulfates with the formula:
R¹¹OSO₃M
wherein R¹¹ is a primary alkyl group of 10 to 18 carbon atoms and M is a sodium cation; and paraffin sulfonates, preferably with 12 to 16 carbon atoms to the alkyl moiety.

Other anionic surfactants preferred for use with this formulation include isethionates, sulfated triglycerides, alcohol sulfates, ligninsulfonates, naphthelene sulfonates and alkyl naphthelene sulfonates and the like.

Cationic Polymer

A cationic polymer is here defined to include polymers which, because of their molecular weight or monomer composition, are soluble or dispersible to at least the extent of 0.01% by weight in distilled water at 25° C. Water soluble cationic polymers include polymers in which one or more of the constituent monomers are selected from the list of copolymerizable cationic or amphoteric monomers. These monomer units contain a positive charge over at least a portion of the pH range 6-11. A partial listing of monomers can be found in the “International Cosmetic Ingredient Dictionary,” 5th Edition, edited by J. A. Wenninger and G. N. McEwen, The Cosmetic, Toiletry, and Fragrance Association, 1993. Another source of such monomers can be found in “Encyclopedia of Polymers and Thickeners for Cosmetics”, by R. Y. Lochhead and W. R. Fron, Cosmetics & Toiletries, vol. 108, May 1993, pp 95-135.

The cationic polymers of this invention are effective at surprisingly low levels. As such, the ratio of cationic polymer to total surfactant in the composition should preferably be no greater than about 1:5, and more preferably less than about 1:10.

Specifically, monomers useful in this invention may be represented structurally as etiologically unsaturated compounds as in formula I. 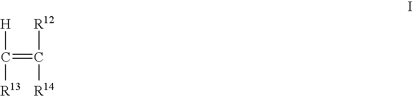
wherein R¹² is hydrogen, hydroxyl, methoxy, or a C₁ to C₃₀ straight or branched alkyl radical; R¹³ is hydrogen, or a C₁₋₃₀ straight or branched alkyl, a C₁₋₃₀ straight or branched alkyl substituted aryl, aryl substituted C₁₋₃₀-straight or branched alkyl radical, or a poly oxyalkene condensate of an aliphatic radical; and R¹⁴ is a heteroatomic alkyl or aromatic radical containing either one or more quaternerized nitrogen atoms or one or more amine groups which possess a positive charge over a portion of the pH interval pH 6 to 11. Such amine groups can be further delineated as having a pKₐ of about 6 or greater.

Examples of cationic monomers of formula I include, but are not limited to, co-poly 2-vinyl pyridine and its co-poly 2-vinyl N-alkyl quaternary pyridinium salt derivatives; co-poly 4-vinyl pyridine and its co-poly 4-vinyl N-alkyl quaternary pyridinium salt derivatives; co-poly 4-vinylbenzyltrialkylammonium salts such as co-poly 4-vinylbenzyltrimethylammonium salt; co-poly 2-vinyl piperidine and co-poly 2-vinyl piperidinium salt; co-poly 4-vinylpiperidine and co-poly 4-vinyl piperidinium salt; co-poly 3-alkyl 1-vinyl imidazolium salts such as co-poly 3-methyl 1-vinyl imidazolium salt; acrylamido and methacrylamido derivatives such as co-poly dimethyl aminopropylmethacrylamide, co-poly acrylamidopropyl trimethylammonium salt and co-poly methacrylamidopropyl trimethylammonium salt; acrylate and methacrylate derivatives such as co-poly dimethyl aminoethyl (meth)acrylate, co-poly ethanaminium N,N,N trimethyl 2-[(1-oxo-2 propenyl) oxy]-salt, co-poly ethanaminium N,N,N trimethyl 2-[(2 methyl-1-oxo-2 propenyl) oxy]-salt, and co-poly ethanaminium N,N,N ethyl dimethyl 2-[(2 methyl-1-oxo-2 propenyl) oxy]-salt.

Also included among the cationic monomers suitable for this invention are co-poly vinyl amine and co-polyvinylammonium salt; co-poly diallylamine, co-poly methyldiallylamine, and co-poly diallydimethylammonium salt; and the ionene class of internal cationic monomers. This class includes co-poly ethylene imine, co-poly ethoxylated ethylene imine and co-poly quaternized ethoxylated ethylene imine; co-poly [(dimethylimino) trimethylene (dimethylimino) hexamethylene disalt], co-poly [(diethylimino) trimethylene (dimethylimino) trimethylene disalt]; co-poly [(dimethylimino) 2-hydroxypropyl salt]; co-polyquarternium-2, co-polyquarternium-17, and co-polyquarternium 18, as defined in the “International Cosmetic Ingredient Dictionary” edited by Wenninger and McEwen.

Additionally, useful polymers are the cationic co-poly amido-amine having the chemical structure of formula II. 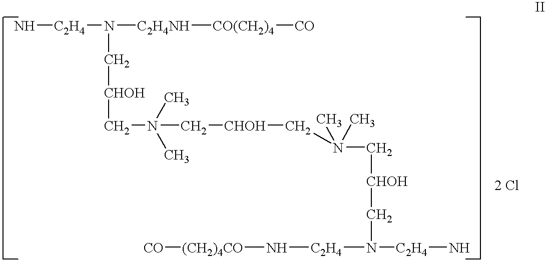
and the quaternized polyimidazoline having the chemical structure of formula III 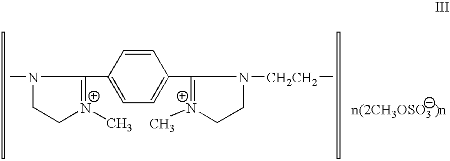
wherein the molecular weight of structures II and III can vary between about 10,000 and 10,000,000 Daltons and each is terminated with an appropriate terminating group such as, for example, a methyl group.

An additional, and highly preferred class of cationic monomers suitable for this invention are those arising from natural sources and include, but are not limited to, cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyidimethylammonium hydroxyethyl cellulose; guar 2-hydroxy-3-(trimethylammonium) propyl ether salt; cellulose 2-hydroxyethyl 2-hydroxy 3-(trimethyl ammonio) propyl ether salt.

It is likewise envisioned that monomers containing cationic sulfonium salts such as co-poly 1-[3-methyl-4-(vinyl-benzyloxy)phenyl] tetrahydrothiophenium chloride would also be applicable to the present invention.

The counterion of the comprising cationic co-monomer is freely chosen from the halides: chloride, bromide, and iodide; or from hydroxide, phosphate, sulfate, hydrosulfate, ethyl sulfate, methyl sulfate, formate, and acetate.

Another class of cationic polymer useful for the present invention are the cationic silicones. These materials are characterized by repeating dialkylsiloxane interspersed or end terminated, or both, with cationic substituted siloxane units. Commercially available materials of this class are the Abil Quat polymers from Degussa Goldschmidt (Va.).

The weight fraction of the cationic polymer which is composed of the above-described cationic monomer units can range from 1 to 100%, preferably from 10 to 100%, and most preferably from 15 to 80% of the entire polymer. The remaining monomer units comprising the cationic polymer are chosen from the class of anionic monomers and the class of nonionic monomers or solely from the class of nonionic monomers. In the former case, the polymer is an amphoteric polymer while in the latter case it can be a cationic polymer, provided that no amphoteric co-monomers are present. Amphoteric polymers should also be considered within the scope of this disclosure, provided that the polymer unit possesses a net positive charge at one or more points over the wash pH range of pH 6 to 11. The anionic monomers comprise a class of monounsaturated compounds which possess a negative charge over the portion of the pH range from pH 6 to 11 in which the cationic monomers possess a positive charge. The nonionic monomers comprise a class of monounsaturated compounds which are uncharged over the pH range from pH 6 to 11 in which the cationic monomers possess a positive charge. It is expected that the wash pH at which this invention would be employed would either naturally fall within the above mentioned portion of the pH range 6-11 or, optionally, would be buffered in that range. A preferred class of both the anionic and the nonionic monomers are the vinyl (ethylenically unsaturated) substituted compounds corresponding to formula IV. 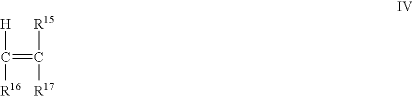
wherein R¹⁵, R¹⁶, and R¹⁷ are independently hydrogen, a C₁ to C₃ alkyl, a carboxylate group or a carboxylate group substituted with a C₁ to C₃₀ linear or branched heteroatomic alkyl or aromatic radical, a heteroatomic radical or a poly oxyalkene condensate of an aliphatic radical.

The class of anionic monomers are represented by the compound described by formula IV in which at least one of the R⁵, R⁶, or R¹⁷ comprises a carboxylate, substituted carboxylate, phosphonate, substituted phosphonate, sulfate, substituted sulfate, sulfonate, or substituted sulfonate group. Preferred monomers in this class include but are not limited to ∀-ethacrylic acid, ∀-cyano acrylic acid, ∃,∃-dimethacrylic acid, methylenemalonic acid, vinylacetic acid, allylacetic acid, acrylic acid, ethylidineacetic acid, propylidineacetic acid, crotonic acid, methacrylic acid, maleic acid, fumaric acid, itaconic acid, sorbic acid, angelic acid, cinnamic acid, ∃-styryl acrylic acid (1-carboxy-4-phenyl butadiene-1,3), citraconic acid, glutaconic acid, aconitic acid, ∀-phenylacrylic acid, ∃-acryloxy propionic acid, citraconic acid, vinyl benzoic acid, N-vinyl succinamidic acid, and mesaconic acid. Also included in the list of preferred monomers are co-poly styrene sulfonic acid, 2-methacryloyloxymethane-1-sulfonic acid, 3-methacryloyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid and vinyl phosphoric acid. Most preferred monomers include acrylic acid, methacrylic acid and maleic acid. The polymers useful in this invention may contain the above monomers and the alkali metal, alkaline earth metal, and ammonium salts thereof.

The class of nonionic monomers are represented by the compounds of formula IV in which none of the R¹⁵, R¹⁶, or R¹⁷ contain the above mentioned negative charge containing radicals. Preferred monomers in this class include, but are not limited to, vinyl alcohol; vinyl acetate; vinyl methyl ether; vinyl ethyl ether; acrylamide, methacrylamide and other modified acrylamides; vinyl propionate; alkyl acrylates (esters of acrylic or methacrylic acid); and hydroxyalkyl acrylate esters. A second class of nonionic monomers include co-poly ethylene oxide, co-poly propylene oxide, and co-poly oxymethylene. A third, and highly preferred, class of nonionic monomers includes naturally derived materials such as hydroxyethylcellulose and guar gum.

It is highly preferred, and often necessary in the case of certain compositions, to formulate the products of this invention with the proper ratio of cationic polymer to anionic surfactant. Too high a ratio can result in reduced softening, poor packing at the interface, unacceptable dissolution times and, in the case of liquid products, an excessively high viscosity which can render the product non-pourable, and thus unacceptable for consumer use. The use of lower ratios of cationic polymer to surfactant also reduces the overall level of polymer necessary for the formulation, which is also preferable for cost and environmental reasons, and gives the formulator greater flexibility in making a stable product. The preferred ratio of cationic polymer: total surfactant will be less than about 1:4, whereas the preferred ratio of cationic polymer:anionic surfactant will be less than about 1:5, and the preferred ratio of cationic polymer:nonionic surfactant will be less than about 1:5. The concentration of cationic polymer will generally be less than about 3% of the total product mass.

Without wishing to be bound by theory, it is believed that the species responsible for providing a conditioning benefit in these formulations is a polymer/surfactant complex. The compositions of this invention comprise at least about 5%, and preferably at least about 10% of one or more surfactants with a hydrophilic/lipophilic balance (HLB, defined in U.S. Pat. No. 6,461,387) of more than about 4.

Many of the aforementioned cationic polymers can be synthesized in, and are commercially available in, a number of different molecular weights. In order to achieve optimal cleaning and softening performance from the product, it is desirable that the water-soluble cationic or amphoteric polymer used in this invention be of an appropriate molecular weight. Without wishing to be bound by theory, it is believed that polymers that are too high in mass can entrap soils and prevent them from being removed. The use of cationic polymers with an average molecular weight of less than about 850,000 daltons, and especially those with an average molecular weight of less than 500,000 daltons can help to minimize this effect without significantly reducing the softening performance of properly formulated products. On the other hand, polymers with a molecular weight of about 10,000 daltons or less are believed to be too small to give an effective softening benefit.

Nonionic Oil

Nonionic oils in the specification to include nonpolar and amphiphilic materials with a water solubility of less than about 1% by weight. Preferably, at least one nonionic oil in the laundry composition has an HLB of less than about 15, more preferably an HLB of less than about 8, and even more preferably an HLB of less than about 6.

Nonionic oils include polydimethylsiloxane, amino functional silicones, triglyceride oils, silicone polyethers, cyclic polyol esters, cyclic polyol ethers, reduced saccharide esters, reduced saccharide ethers, mineral oils and mixtures thereof.

Polydimethylsiloxane and Amino Functional Silicones

Preferably, silicone oil is employed. More preferably, it is either a silicone poly ether or amino-functional silicone. If this invention incorporates a silicone polyether, it is preferably of one of the two general structures shown below: 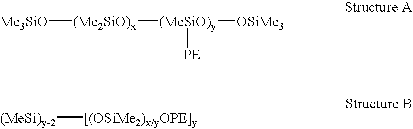
Where PE represents:
   CH₂—CH₂—CH₂—O-(EO)ₘ—(PO)ₙ-Z
   where Me represents methyl; EO represents ethylene oxide; PO represents 1,2 propylene oxide; Z represents either a hydrogen or a lower alkyl radical; x, y, m, n are constants and can be varied to alter the properties of the functionalized silicone.

A molecule of either structure can be used for the purposes of this invention. Preferably, this molecule contains more than 30% silicone, more than 20% ethylene oxide and less than 30% propylene oxide by weight, and has a molecular weight of more than 5,000. An example of a suitable, commercially available such material is L-7622, available from Crompton Corporation, (Greenwich, Conn.)

Reduced Saccharide Esters and Ethers

Oily sugar derivatives suitable for use in this invention are taught in WO 98/16538, which are especially preferred due to their ready availability and favorable environmental profile. When used in the compositions of this invention, such materials are typically present at a level between about 1% and about 60% of the finished composition.

Conditioning Benefits

The compositions of this invention are intended to confer conditioning benefits to garments, home textiles, carpets and other fibrous or fiber-derived articles. These formulations are not to be limited to conditioning benefits, however, and will often be multi-functional.

The primary conditioning benefit afforded by these products is softening. Softening includes, but is not limited to, an improvement in the handling of a garment treated with the compositions of this invention relative to that of an article laundered under identical conditions but without the use of this invention. Consumers will often describe an article that is softened as “silky” or “fluffy”, and generally prefer the feel of treated garments to those that are unsoftened. It is desirable that the formulae of this invention, when used as instructed, yield a softness parameter of more than about 70. The preferred products give a softness parameter of more than about 80.

The conditioning benefits of these compositions are not limited to softening, however. They may, depending on the particular embodiment of the invention selected, also provide an antistatic benefit. The cationic polymers of this invention are also believed to inhibit the transfer, bleeding and loss of vagrant dyes from fabrics during the wash, further improving color brightness over time.

Form of the Invention

The present invention can take any of a number of forms, including a dilutable fabric conditioner that may be an isotropic liquid, a surfactant-structured liquid or any other laundry detergent form known to those skilled in the art. A “dilutable fabric conditioning” composition is defined, for the purposes of this disclosure, as a product intended to be used by being diluted with water or a non-aqueous solvent by a ratio of more than 100:1, to produce a liquor suitable for treating textiles and conferring to them one or more conditioning benefits. As such, compositions intended to be used as combination detergent/softeners, along with fabric softeners sold for application in the final rinse of a wash cycle and fabric softeners sold for application at the beginning of a wash cycle are all considered within the scope of this invention. For all cases, however, these compositions are intended to be used by being diluted by a ratio of more than 100:1 with water or a non-aqueous solvent, to form a liquor suitable for treating fabrics.

The compositions may be in a form of: liquid laundry detergent, powdered laundry detergent, liquid rinse conditioner, powdered rinse conditioner, tableted laundry detergents, laundry booster, laundry sachet and water-soluble sheet.

Particularly preferred forms of this invention include combination detergent/softener products, especially as a liquid, and prefeably and isotropic or surfactant-structured liquid products intended for application as a fabric softener during the wash cycle or the final rinse. For the purposes of this disclosure, the term “fabric softener” shall be understood to mean a consumer or industrial product added to the wash, rinse or dry cycle of a laundry process for the express or primary purpose of conferring one or more conditioning benefits.

The pH range of the composition is about 2 to about 12. As many cationic polymers can decompose at high pH, especially when they contain amine or phosphine moieties, it is desirable to keep the pH of the composition below the pKₐ of the amine or phosphine group that is used to quaternize the selected polymer, below which the propensity for this to occur is greatly decreased. This reaction can cause the product to lose effectiveness over time and create an undesirable product odor. As such, a reasonable margin of safety, of 1-2 units of pH below the pKₐ should ideally be used in order to drive the equilibrium of this reaction to strongly favor polymer stability. Although the preferred pH of the product will depend on the particular cationic polymer selected for formulation, typically these values should be below about 8.5 to about 10. Wash liquor pH, especially in the case of combination detergent/softener products, can often be less important, as the kinetics of polymer decomposition are often slow, and the time of one wash cycle is typically not sufficient to allow for this reaction to have a significant impact on the performance or odor of the product. A lower pH can also aid in the formulation of higher-viscosity products.

Conversely, a product with a pH that is too low will not saponify fatty materials and often will not effectively remove particulate soil. As such, in the most preferred embodiment of this invention, the pH of the product, in the case of a liquid detergent or fabric conditioner, or the pH of a 1% solution of a powder or tablet product, will be greater than about 5.

The formulation may be buffered at the target pH of the composition.

Method of Use

The following details a method for conditioning textiles comprising the steps, in no particular order of:
a. providing a laundry detergent or fabric softener composition comprising anionic surfactant, nonionic oil, and cationic polymer, in ratios and concentrations to effectively soften and condition fabrics under predetermined laundering conditions;
b. contacting one or more articles with the composition at one or more points during a laundering process; and
c. allowing the articles to dry or mechanically tumble-drying them.
   The softening parameter is greater than about 70, preferably greater than about 80, and the composition comprises more than about 5% by weight of surfactant.

Amounts of composition used will generally range between about 10 g and about 300 g total product per 3 kg of conditioned fibrous articles, depending on the particular embodiment chosen and other factors, such as consumer preferences, that influence product use behavior.

A consumer that would use the present invention could also be specifically instructed to contact the fabrics with the inventive composition with the purpose of simultaneously cleaning and softening the said fabrics. This approach would be recommended when the composition takes the form of a softening detergent to be dosed at the beginning of the wash cycle.

Insoluble Matter

It is preferred that the inventive compositions be formulated with low levels, if any at all, of any matter that is substantially insoluble in the solvent intended to be used to dilute the product. For the purposes of this disclosure, “substantially insoluble” shall mean that the material in question can individually be dissolved at a level of less than 0.001% in the specified solvent. Examples of substantially insoluble matter in aqueous systems include, but are not limited to aluminosilicates, pigments, clays and the like. Without wishing to be bound by theory, it is believed that solvent-insoluble inorganic matter can be attracted and coordinated to the cationic polymers of this invention, which are believed to attach themselves to the articles being washed. When this occurs, it is thought that these particles can create a rough effect on the fabric surface, which in turn reduces the perception of softness.

Preferably, insoluble and substantially insoluble matter will be limited to less than 10% of the composition, more preferably to about 5%. Most preferably, especially in the case of liquid conditioning compositions, the composition will be essentially free, or have less than about 5%, of substantially insoluble matter or precipitation.

Optional Ingredients

In addition to the above-mentioned essential elements, the formulator may include one or more optional ingredients, which are often very helpful in rendering the formulation more acceptable for consumer use.

Examples of optional components include, but are not limited to: anionic polymers, uncharged polymers, nonionic surfactants, amphoteric and zwitterionic surfactants, cationic surfactants, hydrotropes, fluorescent whitening agents, photobleaches, fiber lubricants, reducing agents, enzymes, enzyme stabilizing agents, powder finishing agents, defoamers, builders, bleaches, bleach catalysts, soil release agents, dye transfer inhibitors, buffers, colorants, fragrances, pro-fragrances, rheology modifiers, anti-ashing polymers, preservatives, insect repellents, soil repellents, water-resistance agents, suspending agents, aesthetic agents, structuring agents, sanitizers, solvents, fabric finishing agents, dye fixatives, wrinkle-reducing agents, fabric conditioning agents and deodorizers.

Preservatives

Optionally, a soluble preservative may be added to this invention. The use of a preservative is especially preferred when the composition of this invention is a liquid, as these products tend to be especially susceptible to microbial growth.

The use of a broad-spectrum preservative, which controls the growth of bacteria and fungi is preferred. Limited-spectrum preservatives, which are only effective on a single group of microorganisms may also be used, either in combination with a broad-spectrum material or in a “package” of limited-spectrum preservatives with additive activities. Depending on the circumstances of manufacturing and consumer use, it may also be desirable to use more than one broad-spectrum preservative to minimize the effects of any potential contamination.

The use of both biocidal materials, i.e. substances that kill or destroy bacteria and fungi, and biostatic preservatives, i.e. substances that regulate or retard the growth of microorganisms, may be indicated for this invention.

In order to minimize environmental waste and allow for the maximum window of formulation stability, it is preferred that preservatives that are effective at low levels be used. Typically, they will be used only at an effective amount. For the purposes of this disclosure, the term “effective amount” means a level sufficient to control microbial growth in the product for a specified period of time, i.e., two weeks, such that the stability and physical properties of it are not negatively affected. For most preservatives, an effective amount will be between about 0.00001% and about 0.5% of the total formula, based on weight. Obviously, however, the effective level will vary based on the material used, and one skilled in the art should be able to select an appropriate preservative and use level.

Preferred preservatives for the compositions of this invention include organic sulfur compounds, halogenated materials, cyclic organic nitrogen compounds, low molecular weight aldehydes, quaternary ammonium materials, dehydroacetic acid, phenyl and phenoxy compounds and mixtures thereof.

Examples of preferred preservatives for use in the compositions of the present invention include: a mixture of about 77% 5-chloro-2-methyl-4-isothiazolin-3-one and about 23% 2-methyl-4-isothiazolin-3-one, which is sold commercially as a 1.5% aqueous solution by Rohm & Haas (Philadelphia, Pa.) under the trade name Kathon; 1,2-benzisothiazolin-3-one, which is sold commercially by Avecia (Wilmington, Del.) as, for example, a 20% solution in dipropylene glycol sold under the trade name Proxel GXL; and a 95:5 mixture of 1,3 bis (hydroxymethyl)-5,5-dimethyl-2,4 imidazolidinedione and 3-butyl-2-iodopropynyl carbamate, which can be obtained, for example, as Glydant Plus from Lonza (Fair Lawn, N.J.).

Nonionic Surfactants

Nonionic surfactants are useful in the context of this invention to both improve the cleaning properties of the compositions, when used as a detergent, and to contribute to product stability. For the purposes of this disclosure, “nonionic surfactant” shall be defined as amphiphilic molecules with a molecular weight of less than about 10,000, unless otherwise noted, which are substantially free of any functional groups that exhibit a net charge at the normal wash pH of 6-11. Any type of nonionic surfactant may be used, although preferred materials are further discussed below.

Fatty Alcohol Ethoxylates:
R¹⁸O(EO)ₙ

Wherein R¹⁸ represents an alkyl chain of between 4 and 30 carbon atoms, 15 (EO) represents one unit of ethylene oxide monomer and n has an average value between 0.5 and 20. R may be linear or branched. Such chemicals are generally produced by oligomerizing fatty alcohols with ethylene oxide in the presence of an effective amount catalyst, and are sold in the market as, for example, Neodols from Shell (Houston, Tex.) and Alfonics from Sasol (Austin, Tex.). The fatty alcohol starting materials, which are marketed under trademarks such as Alfol, Lial and Isofol from Sasol (Austin, Tex.) and Neodol, from Shell, may be manufactured by any of a number of processes known to those skilled in the art, and can be derived from natural or synthetic sources or a combination thereof. Commercial alcohol ethoxylates are typically mixtures, comprising varying chain lengths of R¹⁸ and levels of ethoxylation. Often, especially at low levels of ethoxylation, a substantial amount of unethoxylated fatty alcohol remains in the final product, as well.

Because of their excellent cleaning, environmental and stability profiles, fatty alcohol ethoxylates wherein R¹⁸ represents an alkyl chain from 10-18 carbons and n is an average number between 5 and 12 are highly preferred.

Alkylphenol Ethoxylates:
R¹⁹ArO(EO)ₙ

Where R¹⁹ represents a linear or branched alkyl chain ranging from 4 to 30 carbons, Ar is a phenyl (C₆H₄) ring and (EO)ₙ is an oligomer chain comprised of an average of n moles of ethylene oxide. Preferably, R¹⁹ is comprised of between 8 and 12 carbons, and n is between 4 and 12. Such materials are somewhat interchangeable with alcohol ethoxylates, and serve much the same function. A commercial example of an alkylphenol ethoxylate suitable for use in this invention is Triton X-100, available from Dow Chemical (Midland, Mich.)

Ethylene Oxide/Propylene Oxide Block Polymers:
(EO)ₓ(PO)_{y}(EO)ₓ or (PO)ₓ(EO)_{y}(PO)ₓ
wherein EO represents an ethylene oxide unit, PO represents a propylene oxide-unit, and x and y are numbers detailing the average number of moles ethylene oxide and propylene oxide in each mole of product. Such materials tend to have higher molecular weights than most nonionic surfactants, and as such can range between 1,000 and 30,000 daltons. BASF (Mount Olive, N.J.) manufactures a suitable set of derivatives and markets them under the Pluronic and Pluronic-R trademarks.

Other nonionic surfactants should also be considered within the scope of this invention. These include condensates of alkanolamines with fatty acids, such as cocamide DEA, polyol-fatty acid esters, such as the Span series available from Uniqema (Wlimington, Del.), ethoxylated polyol-fatty acid esters, such as the Tween series available from Uniqema (Wilmington, Del.), Alkylpolyglucosides, such as the APG line available from Cognis (Gulph Mills, Pa.) and n-alkylpyrrolidones, such as the Surfadone series of products marketed by ISP (Wayne, N.J.). Furthermore, nonionic surfactants not specifically mentioned above, but within the definition, may also be used.

Fluorescent Whitening Agents

Many fabrics, and cottons in particular, tend to lose their whiteness and adopt a yellowish tone after repeated washing. As such, it is customary and preferred to add a small amount of fluorescent whitening agent, which absorbs light in the ultraviolet region of the spectrum and re-emits it in the visible blue range, to the compositions of this invention, especially if they are combination detergent/fabric conditioner preparations.

Suitable fluorescent whitening agents include derivatives of diaminostilbenedisulfonic acid and their alkali metal salts. Particularly, the salts of 4,4′-bis(2-anilino4-morpholino-1,3,5-triazinyl-6-amino)stilbene-2,2′-disulfonic acid, and related compounds where the morpholino group is replaced by another nitrogen-comprising moiety, are preferred. Also preferred are brighteners of the 4,4′-bis(2-sulfostyryl) biphenyl type, which may optionally be blended with other fluorescent whitening agents at the option of the formulator. Typical fluorescent whitening agent levels in the preparations of this invention range between 0.001% and 1%, although a level between 0.1% and 0,3%, by mass, is normally used. Commercial supplies of acceptable fluorescent whitening agents can be sourced from, for example, Ciba Specialty Chemicals (High Point, N.C.) and Bayer (Pittsburgh, Pa.).

Builders

Builders are often added to fabric cleaning compositions to complex and remove alkaline earth metal ions, which can interfere with the cleaning performance of a detergent by combining with anionic surfactants and removing them from the wash liquor. The preferred compositions of this invention contain low levels, if any at all, of builder. Generally, these will comprise less than 10%, preferably less than 7% and most preferably less than 5% by weight of total phosphate and zeolite.

Soluble builders, such as alkali metal carbonates and alkali metal citrates, are particularly preferred, especially for the liquid embodiment of this invention. Other builders, as further detailed below, may also be used, however. Often a mixture of builders, chosen from those described below and others known to those skilled in the art, will be used.

Alkali and Alkaline Earth Metal Carbonates:

Alkali and alkaline earth metal carbonates, such as those detailed in German patent application 2,321,001, published Nov. 15, 1973, are suitable for use as builders in the compositions of this invention. They may be supplied and used either in anhydrous form, or including bound water. Particularly useful is sodium carbonate, or soda ash, which both is readily available on the commercial market and has an excellent environmental profile.

The sodium carbonate used in this invention may either be natural or synthetic, and, depending on the needs of the formula, may be used in either dense or light form. Natural soda ash is generally mined as trona and further refined to a degree specified by the needs of the product it is used in. Synthetic ash, on the other hand, is usually produced via the Solvay process or as a coproduct of other manufacturing operations, such as the synthesis of caprolactam. It is sometimes further useful to include a small amount of calcium carbonate in the builder formulation, to seed crystal formation and increase building efficacy.

Organic Builders:

Organic detergent builders can also be used as nonphosphate builders in the present invention. Examples of organic builders include alkali metal citrates, succinates, malonates, fatty acid sulfonates, fatty acid carboxylates, nitrilotriacetates, oxydisuccinates, alkyl and alkenyl disuccinates, oxydiacetates, carboxymethyloxy succinates, ethylenediamine tetraacetates, tartrate monosuccinates, tartrate disuccinates, tartrate monoacetates, tartrate diacetates, oxidized starches, oxidized heteropolymeric polysaccharides, polyhydroxysulfonates, polycarboxylates such as polyacrylates, polymaleates, polyacetates, polyhydroxyacrylates, polyacrylate/polymaleate and polyacrylate/polymethacrylate copolymers, acrylate/maleate/vinyl alcohol terpolymers, aminopolycarboxylates and polyacetal carboxylates, and polyaspartates and mixtures thereof. Such carboxylates are described in U.S. Pat. Nos. 4,144,226, 4,146,495 and 4,686,062. Alkali metal citrates, nitrilotriacetates, oxydisuccinates, acrylate/maleate copolymers and acrylate/maleate/vinyl alcohol terpolymers are especially preferred nonphosphate builders.

Phosphates:

The compositions of the present invention which utilize a water-soluble phosphate builder typically contain this builder at a level of from 1 to 90% by weight of the composition. Specific examples of water-soluble phosphate builders are the alkali metal tripolyphosphates, sodium, potassium and ammonium pyrophosphate, sodium and potassium orthophosphate, sodium polymeta/phosphate in which the degree of polymerization ranges from about 6 to 21, and salts of phytic acid. Sodium or potassium tripolyphosphate is most preferred.

Phosphates are, however, often difficult to formulate, especially into liquid products, and have been identified as potential agents that may contribute to the eutrophication of lakes and other waterways. As such, the preferred compositions of this invention comprise phosphates at a level of less than about 10% by weight, more preferably less than about 5% by weight. The most preferred compositions of this invention are formulated to be substantially free of phosphate builders.

Zeolites:

Zeolites may also be used as builders in the present invention. A number of zeolites suitable for incorporation into the products of this disclosure are available to the formulator, including the common zeolite 4A. In addition, zeolites of the MAP variety, such as those taught in European Patent Application EP 384,070B, which are sold commercially by, for example, Ineos Silicas (UK), as Doucil A24, are also acceptable for incorporation. MAP is defined as an alkali metal aluminosilicate of zeolite P type having a silicon to aluminium ratio not exceeding 1.33, preferably within the range of from 0.90 to 1.33, more preferably within the range of from 0.90 to 1.20.

Especially preferred is zeolite MAP having a silicon to aluminium ratio not exceeding 1.07, more preferably about 1.00. The particle size of the zeolite is not critical. Zeolite A or zeolite MAP of any suitable particle size may be used. In any event, as zeolites are insoluble matter, it is advantageous to minimize their level in the compositions of this invention. As such, the preferred formulations contain less than about 10% of zeolite builder, while especially preferred compositions comprise less than about 5% zeolite.

Enzyme Stabilizers

When enzymes, and especially proteases are used in liquid detergent formulations, it is often necessary to include a suitable quantity of enzyme stabilizer to temporarily deactivate it until it is used in the wash. Examples of suitable enzyme stabilizers are well-known to those skilled in the art, and include, for example, borates and polyols such as propylene glycol. Borates are especially suitable for use as enzyme stablizers because in addition to this benefit, they can further buffer the pH of the detergent product over a wide range, thus providing excellent flexibility.

If a borate-based enzyme stabilization system is chosen, along with one or more cationic polymers that are at least partially comprised of carbohydrate moeities, stability problems can result if suitable co-stablizers are not used. It is believed that this is the result of borates' natural affinity for hydroxyl groups, which can create an insoluble borate-polymer complex that precipitates from solution either over time or at cold temperatures. Incorporating into the formulation a co-stabilizer, which is normally a diol or polyol, sugar or other molecule with a large number of hydroxyl groups, can ordinarily prevent this. Especially preferred for use as a co-stabilizer is sorbitol, used at a level that is at least about 0.8 times the level of borate in the system, more preferably 1.0 times the level of borate in the system and most preferably more than 1.43 times the level of borate in the system, is sorbitol, which is effective, inexpensive, biodegradable and readily available on the market. Similar materials including sugars such as glucose and sucrose, and other poyols such as propylene glycol, glycerol, mannitol, maltitol and xylitol, should also be considered within the scope of this invention.

Fiber Lubricants

In order to enhance the conditioning, softening, wrinkle-reduction and protective effects of the compositions of this invention, it is often desirable to include one or more fiber lubricants in the formulation. Such ingredients are well known to those skilled in the art, and are intended to reduce the coefficient of friction between the fibers and yarns in articles being treated, both during and after the wash process. This effect can in turn improve the consumer's perception of softness, minimize the formation of wrinkles and prevent damage to textiles during the wash. For the purposes of this disclosure, “fiber lubricants” shall be considered non-cationic materials intended to lubricate fibers for the purpose of reducing the friction between fibers or yarns in an article comprising textiles which provide one or more wrinkle-reduction, fabric conditioning or protective benefit.

Examples of suitable fiber lubricants include, functionalized plant and animal-derived oils, natural and synthetic waxes and the like. Such ingredients often have low HLB values, less than about 10, although exceeding this level is not outside of the scope of this invention. Various levels of derivatization may be used provided that the derivatization level is sufficient for the oil or wax derivatives to become soluble or dispersible in the solvent it is used in so as to exert a fiber lubrication effect during laundering of fabrics with a detergent containing the oil or wax derivative.

When the use of a fiber lubricant is elected, it will generally be present as between 0.1% and 15% of the total composition weight.

Bleach Catalyst

An effective amount of a bleach catalyst can also be present in the invention. A number of organic catalysts are available such as the sulfonimines as described in U.S. Pat. Nos. 5,041,232; 5,047,163 and 5,463,115.

Transition metal bleach catalysts are also useful, especially those based on manganese, iron, cobalt, titanium, molybdenum, nickel, chromium, copper, ruthenium, tungsten and mixtures thereof. These include simple water-soluble salts such as those of iron, manganese and cobalt as well as catalysts containing complex ligands.

Suitable examples of manganese catalysts containing organic ligands are described in U.S. Pat. No. 4,728,455, U.S. Pat. No. 5,114,606, U.S. Pat. No. 5,153,161, U.S. Pat. No. 5,194,416, U.S. Pat. No. 5,227,084, U.S. Pat. No. 5,244,594, U.S. Pat. No. 5,246,612, U.S. Pat. No. 5,246,621, U.S. Pat. No. 5,256,779, U.S. Pat. No. 5,274,147, U.S. Pat. No. 5,280,117 and European Pat. App. Pub. Nos. 544,440, 544, 490, 549,271 and 549,272. Preferred examples of these catalysts include Mn^{IV}₂(u-O)₂(1,4,7-trimethyl-1,4,7-triazacyclononane)₂(PF₆)₂, Mn^{III}₂(u-O)₁ (u-OAc)₂(1,4,7-trimethyl-1,4,7-triazacyclononane)₂(ClO₄)₂, Mn^{IV}₄(u-O)₆(1,4,7-triazacyclononane)₄ (ClO₄)₄, Mn^{III}Mn^{IV}₄(u-O)₁(u-OAc)₂(1,4,7-trimethyl-1,4,7-triazacyclononane)₂(ClO₄)₃, Mn^{IV}(1,4,7-trimethyl-1,4,7-triazacyclononane)-(OCH₃)₃(PF₆), and mixtures thereof. Other metal-based bleach catalysts include those disclosed in U.S. Pat. No. 4,430,243 and U.S. Pat. No. 5,114,611. Other examples of complexes of transition metals include Mn gluconate, Mn(CF₃SO₃)₂, and binuclear Mn complexed with tetra-N-dentate and bi-N-dentate ligands, including [bipy₂Mn^{IV}(u-O)₂Mn^{IV} bipy₂]-(ClO₄)₃.

Iron and manganese salts of aminocarboxylic acids in general are useful herein including iron and manganese aminocarboxylate salts disclosed for bleaching in the photographic color processing arts. A particularly useful transition metal salt is derived from ethylenediaminedisuccinate and any complex of this ligand with iron or manganese.

Another type of bleach catalyst, as disclosed in U.S. Pat. No. 5,114,606, is a water soluble complex of manganese (II), (III), and/or (IV) with a ligand which is a non-carboxylate polyhydroxy compound having at least three consecutive C—OH groups. Preferred ligands include sorbitol, iditol, dulsitol, mannitol, xylithol, arabitol, adonitol, meso-erythritol, meso-inositol, lactose and mixtures thereof. Especially preferred is sorbitol.

Other bleach catalysts are described, for example, in European Pat. App. Pub. Nos. 408,131 (cobalt complexes), 384,503 and 306,089 (metallo-porphyrins), U.S. Pat. No. 4,728,455 (manganese/multidenate ligand), U.S. Pat. No. 4,711,748 (absorbed manganese on aluminosilicate), U.S. Pat. No. 4,601,845 (aluminosilicate support with manganese, zinc or magnesium salt), U.S. Pat. No. 4,626,373 (manganese/ligand), U.S. Pat. No. 4,119,557 (ferric complex), U.S. Pat. No. 4,430,243 (Chelants with manganese cations and non-catalytic metal cations), and U.S. Pat. No. 4,728,455 (manganese gluconates).

Useful catalysts based on cobalt are described in WO 96/23859, WO 96/23860 and WO 96/23861 and U.S. Pat. No. 5,559,261. WO 96/23860 describe cobalt catalysts of the type [COₙLₘXₚ]^{Z}Y_{z}, where L is an organic ligand molecule containing more than one heteroatom selected from N, P, O and S; X is a co-ordinating species; n is preferably 1 or 2; m is preferably 1 to 5; p is preferably 0 to 4 and Y is a counterion. One example of such a catalyst is N,N′-Bis(salicylidene)ethylenediaminecobalt (II). Other cobalt catalysts described in these applications are based on Co(III) complexes with ammonia and mono-, bi-, tri- and tetradentate ligands such as [Co(NH₃)₅OAc]²⁺ with Cl⁻OAc⁻, PF₆⁻, SO₄⁼, and BF₄⁻ anions.

Certain transition-metal containing bleach catalysts can be prepared in the situ by the reaction of a transition-metal salt with a suitable chelating agent, for example, a mixture of manganese sulfate and ethylenediaminedisuccinate. Highly colored transition metal-containing bleach catalysts may be co-processed with zeolites to reduce the color impact.

When present, the bleach catalyst is typically incorporated at a level of about 0.0001 to about 10% by wt., preferably about 0.001 to about 5% by weight.

Hydrotropes

In many liquid and powdered detergent compositions, it is customary to add a hydrotrope to modify product viscosity and prevent phase separation in liquids, and ease dissolution in powders.

Two types of hydrotropes are typically used in detergent formulations and are applicable to this invention. The first of these are short-chain functionalized amphiphiles. Examples of short-chain amphiphiles include the alkali metal salts of xylenesulfonic acid, cumenesulfonic acid and octyl sulfonic acid, and the like. In addition, organic solvents and monohydric and polyhydric alcohols with a molecular weight of less than about 500, such as, for example, ethanol, isoporopanol, acetone, propylene glycol and glycerol, may also be used as hydrotropes.

The following examples will more fully illustrate the embodiments of this invention. All parts, percentages and proportions referred to herein and in the appended claims are by weight unless otherwise illustrated. Physical test methods are described below.

### TEST METHOD AND EXAMPLES

Fabric was washed with a variety of product, the formulations for which are set forth hereinbelow. The washed fabric was then tested by consumer panels for perceived softening. For each of the washes, product was added to a top loading Whirlpool washing machine that contained 17 gallons of water and 6 pounds of fabric. There were several 86% cotton/14% polyester hand towels in each machine along with 100% cotton sheets to bring the total weight of the fabric to 6 pounds. The temperature of the water for the washes was 32 deg. C. and the fabrics were washed for 12 minutes. After the rinse cycle, the fabrics were tumble dried. Two washes were done with each product. Each formula tested is benchmarked against two controls—one using a model detergent (dosed at 120 g at the beginning of the wash), and one using a model detergent plus a model liquid fabric softener. For the latter control, 120 g of the softening formula is added at the beginning of the rinse cycle.

The formula for the model detergent is:

TABLE 1
Model Detergent

| | Percent in Formula |
|---|---|
| Ingredient | (based on 100% active) |
| Sodium linear | 10.2 |
| alkylbenzenesulfonate | |
| Alcohol ethoxylate | 9.5 |
| Sodium silicate | 3.3 |
| Hydrotrope | 0.5 |
| Sodium stearate | 0.4 |
| Fluorescent whitening agent | 0.1 |
| Water | to 100 |

The formula for the model liquid fabric softener is:

TABLE 2
Model Liquid Fabric Softener

| | Percent in Formula |
|---|---|
| Ingredient | (based on 100% active) |
| Dihydrogenated tallow dimethyl | 3.5 |
| ammonium chloride | |
| Lactic acid | 0.015 |
| Calcium chloride | 0.015 |
| Water | To 100 |

Five panelists scored the softness of the hand towels on a 0-10 scale with 0 being “not soft at all” and 10 being “extremely soft”. Duplicate panels were run based on the duplicate washes and the scores averaged over the two runs. A softening parameter (SP) was then calculated using the following formula:
SP=[(Sₜ−S_{d})/(S_{c}−S_{d})]×100
Where,
Sₜ is the softening score for the formula being tested
S_{d} is the softening score for model detergent, and
S_{c} is the softening score for the model detergent+model liquid fabric softener.
   These liquids were used as combination detergent/softeners and dosed at 142 grams per wash.

Detergency experiments were carried out via a modification of ATSM Method D 3050-87 using a Terg-O-Tometer (available from SCS, Fairfield, N.J.) set to 100 RPM in 1000 ml of 90 F water standardized to 120 ppm hardness with a Ca/Mg ratio of 2:1. Cloths were washed for 10 minutes with 2.21 g of detergent, followed by a 2 minute rinse and then tumble dried. Two types of standard soil cloth were used for each experiment: pigment/synthetic sebum on cotton (WFK-10d, available from WFK Testgewebe Gmbh, Bruggen-Bracht Germany) and pigment/oil on poly-cotton (PC-9, Available from C.F.T, Vlaardingen, Holland). Four cloths were used for each wash, and read prior to and after washing by a reflectometer (available from Hunterlab, Reston, Va.) using the D65 illuminant and 10° observer. Results are reported in terms of a Cleaning Parameter, ΔR_{d}, which is calculated as:
ΔR_{d}=R_{F}−R_{I}
where:
R_{F}=average reflectance of the monitor cloths after washing and
R_{I}=average reflectance of the monitor cloths prior to washing.
   Higher values of ΔR_{d} are reflective of better cleaning.

### Example 1

This example demonstrates how good softening can be attained from formulations comprising a variety of different hydrophobic oils in conjunction with a cationic polymer and a surfactant base.

TABLE 3
Formulation 1: Low-HLB Nonionic Oil

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Ryoto L-595¹ | 5.0 |
| Ucare Polymer LR-400² | 0.3 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo.
²Available from Amerchol division of the Dow Chemical Company, Edison, N.J.

TABLE 4
Formulation 2: High HLB Nonionic Oil

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Ryoto LWA-1570¹ | 5.0 |
| Ucare Polymer LR-400² | 0.3 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 15, available from Mitsubishi-Kagaku Foods Corporation, Tokyo.
²Available from Amerchol division of the Dow Chemical Company, Edison, N.J.

TABLE 5
Formulation 3: 10,000 cS Silicone Oil

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Dow Corning 37 Emulsion¹ | 5.0 |
| Ucare Polymer LR-400² | 0.3 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Silicone emulsion, 35%, 10,000 cS, available from Dow Corning, Midland, MI. Silicone level is reported on an active basis.
²Available from Amerchol division of the Dow Chemical Company, Edison, N.J.

TABLE 6
Comparative Formulation 1: No Polymer

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Ryoto L-595¹ | 5.0 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo

TABLE 7
Comparative Formulation 2: No Oil

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Ucare Polymer LR-400¹ | 0.3 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Available from Amerchol division of the Dow Chemical Company, Edison, N.J.

The pH of each formula was adjusted to 8.5 with NaOH or HCl, as necessary.

A softening experiment, as described above, was conducted on formulations 1-3 and comparative formulations 1-2. The following table details its results:

TABLE 8
Softening Results for Formulations 1-3 and
Comparative Formulations 1-2

| Formulation | Softening Parameter |
|---|---|
| 1 | 91 |
| 2 | 86 |
| 3 | 72 |
| Comparative 1 | −1.3 |
| Comparative 2 | 15 |

These results demonstrate that the combination of a cationic polymer, such as Polymer LR-400 and a nonionic oil, such as a silicone or sugar ester, can give excellent softening-in-the-wash. Both components are required for this benefit to be present, however, as the lack of either element will significantly reduce the benefit afforded. While directional, these results also show that formulating these products with a nonionic oil over a lower HLB, preferably less than about 15, is favorable.

### Example 2

The following example demonstrates how formulations lacking anionic surfactant and those with high levels of cationic monomeric surfactant do not deliver the same softening benefit as the compositions of this invention. In addition, this example shows how modifying these parameters can yield unfavorable consumer parameters, such as high or low viscosities and phase separation.

TABLE 9
Comparative Formulation 3: Comprises no Anionic Surfactant

| | Percent in Formula |
|---|---|
| Ingredient | (based on 100% active) |
| Alcohol Ethoxylate | 10.0 |
| Ryoto L-595¹ | 5.0 |
| Ucare Polymer LR-400² | 0.3 |
| Ethanol 95% | 10.0 |
| Dowanol DPnP | 4.0 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo.
²Available from Amerchol division of the Dow Chemical Company, Edison, N.J.

TABLE 10
Comparative Formulation 4: Comprises cationic monomeric surfactant

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Cetyl Trimethyl Ammonium | 3.0 |
| Chloride | |
| Ryoto L-595¹ | 5.0 |
| Ucare Polymer LR-400² | 0.3 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo.
²Available from Amerchol division of the Dow Chemical Company, Edison, N.J.

TABLE 11
Comparative Formulation 5: Comprises High Level of Cationic Polymer

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Ryoto L-595¹ | 5.0 |
| Ucare Polymer LR-400² | 3.0 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo.
²Available from Amerchol division of the Dow Chemical Company, Edison, N.J.

The following table details the softening results for these two formulas and compares them with Formulation 1:

TABLE 12
Softening Results for Formulation 1 and
Comparative Formulations 1-3

| Formulation | Softening Parameter |
|---|---|
| 1 | 91 |
| Comparative 3 | 34 |
| Comparative 4 | 47 |
| Comparative 5 | 56 |

As shown, both formulating these products without one or more anionic surfactants and the addition of one or more cationic, monomeric surfactants can significantly detract from the softening benefit offered by these compositions. Excess polymer can also cause the softening benefit to be less than optimal.

Consumer hedonics were also measured for Formulation 1 and each of the comparative formulations. Typical commercial laundry detergents are stable for at least 60 days at room temperature and have room temperature Brookfield viscosities between 50 and 2,000 cP at room temperature of about 25 deg. C., as liquids that are significantly thicker than this are considered “messy” and difficult to pour, while thinner liquids too closely resemble water. The following table shows viscosity and stability data for each product.

TABLE 13
Consumer Hedonics of Formulation 1 and Comparative
Formulations 1-3

| Formulation | Stability @ 60 Days | Viscosity |
|---|---|---|
| 1 | Stable | 125 |
| Comparative 3 | Stable | 32 |
| Comparative 4 | Phase Separated | Not Meas. |
| Comparative 5 | Stable | 17,480 |

These results show that the optimal level of cationic polymer for the compositions of this invention is less than about 3%, and that the presence of anionic surfactants but absence of cationic monomeric surfactants can maximize both softening and other properties that consumers desire

### Example 3

This example demonstrates how the cleaning performance of the fabric conditioning compositions comprising cationic polymers, anionic surfactants and nonpolar oils can be improved by selecting an appropriate cationic polymer, pH, surfactant level and the presence of oil.

TABLE 14
Formulation 4: Comprises Polymer of Optimal Molecular Weight,
Hydrophobic Oil and more than 5% Surfactant at a pH of 8.5.

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Ryoto L-595¹ | 5.0 |
| Ucare Polymer LR-400² | 0.5 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo.
²Available from Amerchol division of the Dow Chemical Company, Edison, N.J.

TABLE 15
Comparative Formulation 6: Comprises Optimal Cationic Polymer
and Surfactant Level, but Formulated to a pH of less than 5.

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Ryoto L-595¹ | 5.0 |
| Ucare Polymer LR-400² | 0.5 |
| Ethanol 95% | 10.0 |
| Dowanol DPnP | 4.0 |
| Sodium Hydroxide | 0.9 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo.
²Available from Amerchol division of the Dow Chemical Company, Edison, N.J.

The pH of this formulation was then adjusted to 4.5 with caustic and citric acid.

TABLE 16
Comparative Formulation 7: Comprises a Cationic Polymer with a
Molecular Weight and Charge Density that are too high

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Ryoto L-595¹ | 5.0 |
| Ucare Polymer JR-30M² | 0.5 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo.
²Available from Amerchol division of the Dow Chemical Company, Edison, N.J.

TABLE 17
Comparative Formulation 8: Comprises no Oil

| | Percent in Formula |
|---|---|
| Ingredient | (based on 100% active) |
| Alcohol Ethoxylate | 10.0 |
| Linear Alkylbenzene Sulfonic | 8.0 |
| Acid | |
| Lauryl Ether Sufate | 3.0 |
| Ucare Polymer LR-400² | 0.5 |
| Ethanol 95% | 10.0 |
| Dowanol DPnP | 4.0 |
| Sodium Hydroxide | 2.46 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo.
²Available from Amerchol division of the Dow Chemical Company, Edison, N.J.

TABLE 18
Comparative Formulation 9: Comprises less than 5% surfactant

| | Percent in Formula |
|---|---|
| Ingredient | (based on 100% active) |
| Alcohol Ethoxylate | 3.0 |
| Linear Alkylbenzene Sulfonic | 1.5 |
| Acid | |
| Ryoto L-595¹ | 5.0 |
| Ucare Polymer LR-400² | 0.5 |
| Ethanol 95% | 10.0 |
| Dowanol DPnP | 4.0 |
| Sodium Hydroxide | 0.3 |
| Triethanolamine | 1.0 |
| Sorbitol | 5.0 |
| Sodium Borate | 3.0 |
| Proteolytic Enzyme | 0.5 |
| Fluorescent Whitening Agent | 0.2 |
| Water | to 100 |

¹Sucrose ester, HLB 5, available from Mitsubishi-Kagaku Foods Corporation, Tokyo.
²Available from Amerchol division of the Dow Chemical Company, Edison, N.J.

A detergency experiment was performed using both formulations, the results of which are shown in the following table.

TABLE 19
Cleaning Performance of Formulation 4 and Comparative
Formulations 6-9

| Formulation | ΔR_{d} (WFK-10d) | ΔR_{d} (PC-9) |
|---|---|---|
| 4 | 10.22 | 9.56 |
| Comparative 6 | 7.63 | 8.93 |
| Comparative 7 | 5.50 | 7.83 |
| Comparative 8 | 6.80 | 7.36 |
| Comparative 9 | 8.04 | 8.63 |

### Example 4

This example shows various formulations that can be prepared within the scope of this invention:

TABLE 20
Formulation 20 - Liquid Laundry Detergent A

| | Percent in Formula |
|---|---|
| Ingredient | (based on 100% active) |
| Alcohol Ethoxylate | 4-25 |
| Total Anionic Surfactant¹ | 5-50 |
| Propylene Glycol | 0-10 |
| Sodium Hydroxide | 0.1-5 |
| Triethanolamine | 0-5 |
| Sodium Citrate | 0-10 |
| Sodium Borate | 0-10 |
| Nonionic Oil | 1-60 |
| Polymer LR-400 | 0.1-5 |
| Fluorescent Whitening Agent | 0-1 |
| Antiredeposition Polymer | 0-2 |
| Protease Enzyme | 0-1 |
| Lipase Enzyme | 0-1 |
| Cellulase Enzyme | 0-1 |
| Perfume | 0-2 |
| Preservative | 0-1 |
| Soil Release Polymer | 0-2 |
| Water | to 100 |

¹e.g. linear alkyl benzene sulfonic acid; neutralized fatty acids (including oleic; coconut; stearic); secondary alkane sulfonate; alcohol ethoxy sulfate

TABLE 21
Formulation 21 - Liquid Laundry Detergent B

| | Percent in Formula |
|---|---|
| Ingredient | (based on 100% active) |
| Ethoxylated Nonionics | 4.0-25.0 |
| Total Anionic Surfactant¹ | 5-50 |
| Sodium Hydroxide | 0-10.0 |
| Polymer JR 30M | 0.1-5.0 |
| Sodium Xylene Sulfonate | 0-8.0 |
| Nonionic Oil | 1-60 |
| Sodium silicate | 1.0-12.0 |
| Fluorescent Whitening | 0-0.4 |
| Agent | |
| Fragrance | 0-1.0 |
| Water | to 100 |

¹e.g. linear alkyl benzene sulfonic acid; neutralized fatty acids (including oleic; coconut; stearic); secondary alkane sulfonate; alcohol ethoxy sulfate

Typically one wash with a detergent prepared with and without the inventive cationic polymer/anionic surfactant mixture is performed using approximately 90-150 g of liquid detergent in 17 gallons of water at 35 deg. Celsius.

TABLE 22
Formulation 22 - Liquid Fabric Conditioner

| | Percent in Formula |
|---|---|
| Ingredient | (based on 100% active) |
| Total anionic surfactant¹ | 5.0-50.0 |
| Polymer LR-400 | 0.1-5.0 |
| Sodium Xylene Sulfonate | 0-8.0 |
| Triethanolamine | 0-5 |
| Nonionic Oil | 1-60 |
| Fluorescent Whitening | 0-0.4 |
| Agent | |
| Fragrance | 0-1.0 |
| Water | to 100 |

¹e.g. linear alkyl benzene sulfonic acid; neutralized fatty acids (including oleic; coconut; stearic); secondary alkane sulfonate; alcohol ethoxy sulfate

Typically one wash (either added at the beginning of the wash or beginning of the rinse cycle) with a softener prepared with and without the inventive cationic polymer/anionic surfactant mixture is performed using approximately 25-150 g of liquid softener in 17 gallons of water at 35 deg. Celsius.

TABLE 23
Formulation 23 - Laundry Detergent Powder

| | Percent in Formula |
|---|---|
| Ingredient | (based on 100% active) |
| Ethoxylated Nonionics | 2.0-20.0 |
| Total Anionic Surfactant¹ | 4.0-20.0 |
| Sodium Hydroxide | 1.0-8.0 |
| Sodium Aluminosilicate | 0-25.0 |
| Sodium Carbonate | 0-30.0 |
| Sodium Sulfate | 0-30.0 |
| Sodium Silicate | 0.1-3.0 |
| Antiredeposition Agent | 0-3.0 |
| Sodium Perborate | 0-8.0 |
| Nonionic Oil | 1-60 |
| Protease Enzyme | 0-2.0 |
| Fragrance | 0-1.5 |
| Fluorescent Whitening Agent | 0-2.0 |
| Polymer LR-400 | 0.1-10.0 |
| Water | to 100 |

¹e.g. linear alkyl benzene sulfonic acid; neutralized fatty acids (including oleic; coconut; stearic); secondary alkane sulfonate; alcohol ethoxy sulfate

Typically one wash with a detergent prepared with and without the inventive cationic polymer/anionic surfactant mixture is performed using approximately 50-90 g of powdered detergent in 17 gallons of water at 35 deg. Celsius.

TABLE 24
Formulation 24 - Laundry Detergent Tablet

| | Percent in Formula |
|---|---|
| Ingredient | (based on 100% active) |
| Ethoxylated nonionics | 2.0-15.0 |
| total anionic | 3.0-20.0 |
| surfactant¹ | |
| Sodium Hydroxide | 1.0-8.0 |
| Sodium Aluminosilicate | 5.0-25.0 |
| Sodium Carbonate | 5.0-40.0 |
| Sodium Sulfate | 1.0-10.0 |
| Sodium Acetate | 10.0-40.0 |
| Trihydrate | |
| Fluorescent Whitener | 0-2.0 |
| Nonionic Oil | 1-60 |
| Fragrance | 0-2.0 |
| protease Enzyme | 0-2.0 |
| Antiredeposition Agent | 0-2.0 |
| Polymer LR-400 | 0.1-10.0 |
| Water | to 100 |

¹e.g. linear alkyl benzene sulfonic acid; neutralized fatty acids (including oleic; coconut; stearic); secondary alkane sulfonate; alcohol ethoxy sulfate

Typically one wash with a detergent prepared with and without the inventive cationic polymer/anionic surfactant mixture is performed using 2 detergent tablets weighing approximately 40 g each in 17 gallons of water at 35 deg. Celsius.

TABLE 25
Formulation 25 - Fabric Conditioning Powder

| | Percent in Formula |
|---|---|
| Ingredient | (based on 100% active) |
| Total Anionic | 20.0-90.0 |
| Surfactant¹ | |
| Polymer LR-400 | 0.1-15 |
| Sodium Carbonate | 0-40.0 |
| Sodium Sulfate | 0-10.0 |
| Sodium Bicarbonate | 0-40.0 |
| Nonionic Oil | 1-60 |
| Sodium Chloride | 0-40.0 |
| Perfume | 0-2.0 |
| Water | To 100 |

¹e.g. linear alkyl benzene sulfonic acid; neutralized fatty acids (including oleic; coconut; stearic); secondary alkane sulfonate; alcohol ethoxy sulfate

Typically one wash with a conditioner prepared with and without the inventive cationic polymer/anionic surfactant mixture is performed using approximately 40-150 g of powdered fabric conditioner in 17 gallons of water at 35 deg. Celsius.

TABLE 26
Formulation 26 - Water Soluble Sheet

| | Percent in Formula |
|---|---|
| Ingredient | (based on 100% active) |
| Water Soluble Sheet Material | 1.0-30.0 |
| Total Anionic Surfactant¹ | 20.0-95.0 |
| Polymer LR-400 | 0.1-15 |
| Nonionic Oil | 1-60 |
| Perfume | 0-5.0 |

¹e.g. linear alkyl benzene sulfonic acid; neutralized fatty acids (including oleic; coconut; stearic); secondary alkane sulfonate; alcohol ethoxy sulfate

Typically one wash with a softener prepared with and without the inventive cationic polymer/anionic surfactant mixture is performed using 1 or 2 approximately 15-35 g sheets in 17 gallons of water at 35 deg. Celsius.

TABLE 27
Formulation 27 - Water Soluble Sachet

| | Percent in Formula |
|---|---|
| Ingredient | (based on 100% active) |
| Water Soluble Sheet Material | 0.3-10.0 |
| Total Anionic Surfactant¹ | 10.0-70.0 |
| Polymer JR 30M | 0.1-15 |
| Non-Aqueous Liquid Carrier² | 15.0-75.0 |
| Nonionic Oil | 1-60 |
| Water | 2.0-10.0 |
| Perfume | 0-5.0 |

¹e.g. linear alkyl benzene sulfonic acid; neutralized fatty acids (including oleic; coconut; stearic); secondary alkane sulfonate; alcohol ethoxy sulfate
²e.g. propylene glycol; glycerol; glycol ether; alcohol ethoxylate

Typically one wash with a softener prepared with and without the inventive cationic polymer/anionic surfactant mixture is performed using 1 or 2 approximately 20-50 g sachets in 17 gallons of water at 35 deg. Celsius.

TABLE 28
Formulation 28 - Stain Repellency Liquid¹

| | Percent in Formula (based on |
|---|---|
| Ingredient | 100% active) |
| Polymer LR-400² | 0.1-15.0 |
| Total Anionic Fluorocarbon | 2.0-20.0 |
| Surfactant³ | |
| Nonionic Oil | 1-60 |
| Sodium hydroxide | 0.05-2.0 |
| Perfume | 0-5.0 |

¹Final pH adjusted to between 9 and 10 with NaOH
²Available from Amerchol/Dow, Midland, Michigan, USA.
³e.g. Zonyl FSA, Zonyl FSP, and Zonyl TBS all available from DuPont, Wilmington, Delaware

Typically one wash with prepared with and without the inventive cationic polymer/anionic fluorocarbon surfactant mixture added at the beginning of the rinse cycle is performed using approximately 50-200 g of stain repellency liquid in 17 gallons of water.

The above-identified inventive cationic polymer/anionic surfactant/nonionic oil mixtures may be incorporated in liquid, powdered/granular, semi-solid or paste, molded solid or tablet, and water soluble sheet compositions.

### Example 5

This comparative example demonstrates that the inventive compositions of the present invention a re superior to commercially available softening detergents with respect to delivering softening through the wash benefits. Bold™ powder, Yes™ liquid and Solo™ liquid were purchased at a retail store and used according to the instructions on the package for a “normal” load size. Washes were carried out as described in the test method above and the softening parameters measured. They were determined to be:

TABLE 29
Softening Parameters of Competitive Softening Detergents

| Commercial Softening | |
|---|---|
| Detergent | Softening Parameter |
| Bold ™ powder | 0 |
| Yes ™ liquid | 6 |
| Solo ™ liquid | 0 |

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A laundry composition comprising:
(a) a cationic polymer having a weight average molecular weight of less than about 850,000 daltons;
(b) about 1% to about 60% of a nonionic oil; and
(c) at least about 5% of a surfactant selected from the group consisting of anionic surfactant, cationic monomeric surfactant, nonionic surfactant, zwiterionic surfactant, and combinations thereof;
wherein the ratio of said cationic polymer to said nonionic oil is less than about 0.25;
wherein the ratio of said cationic monomeric surfactant to said nonionic oil is less than about 0.2; and
having a Softening Parameter of greater than about 70.

2. The composition according to claim 1, wherein said nonionic oil has an HLB of less than about 15.

3. The composition according to claim 1, wherein said nonionic oil has an HLB of less than about 8.

4. The composition according to claim 1, wherein the level of cationic monomeric surfactant is less than about 3%.

5. The composition according to claim 1, wherein the level of cationic polymer is less than about 3%.

6. The composition according to claim 1, wherein the ratio of said anionic surfactant to said nonionic oil is greater than about 1.

7. The composition according to claim 1, wherein the composition is a liquid with a pH of greater than about 5.

8. The composition according to claim 1, wherein a 1% aqueous solution of said composition has a pH of greater than about 5.

9. The composition according to claim 1, wherein at least one cationic polymer is selected from the group consisting of dimethyl diallyl ammonium chloride/acrylamide copolymers, dimethyl diallyl ammonium chloride/acrylic acid/acrylamide terpolymers, vinylpyrrolidone/methyl vinyl imidazolium chloride copolymers, polydimethyl diallyl ammonium chloride, starch hydroxypropyl trimmonium chloride, polymethacryl amidopropyl trimethyl ammonium chloride, acrylamidopropyl trimmonium chloride/acrylamide copolymers, guar hydroxypropyl trimonium chloride, cationically-modified siloxane polymers and hydroxyethyl cellulose derivatized with trimethyl ammonium substituted epoxide.

10. The composition according to claim 1, wherein said nonionic oil is selected from the group consisting of: polydimethylsiloxane, amino functional silicones, triglyceride oils, silicone polyethers, cyclic polyol esters, cyclic polyol ethers, reduced saccharide esters, reduced saccharide ethers, mineral oils and mixtures thereof.

11. The composition according to claim 1, having a form selected from the group consisting of liquid laundry detergent, powdered laundry detergent, liquid rinse conditioner, powdered rinse conditioner, tablet laundry detergents, laundry booster, laundry sachet and water-soluble sheet.

12. A method for conditioning textiles comprising, in no particular order, the steps of:
a) providing a laundry composition according to claim 1, in an effective amount to soften and condition fabric articles under predetermined laundering conditions
b) contacting one or more articles with said composition at one or more points during a laundering process
c) allowing the article or articles to dry or mechanically tumble-drying them.

13. The method according to claim 12, wherein the ratio of cationic monomeric surfactant to nonionic oil in said laundry composition is less than about 0.2.

14. The method according to claim 12, wherein at least one nonionic oil in said laundry composition has an HLB of less than about 8.

15. The method according to claim 12, wherein the ratio of said anionic surfactant to said nonionic oil in said laundry composition is greater than about 1.

16. The method according to claim 12, wherein at least one cationic polymer in said laundry composition is selected from the group consisting of dimethyl diallyl ammonium chloride/acrylamide copolymers, dimethyl diallyl ammonium chloride/acrylic acid/acrylamide terpolymers, vinylpyrrolidone/methyl vinyl imidazolium chloride copolymers, polydimethyl diallyl ammonium chloride, starch hydroxypropyl trimmonium chloride, polymethacryl amidopropyl trimethyl ammonium chloride, acrylamidopropyl trimmonium chloride/acrylamide copolymers, guar hydroxypropyl trimonium chloride, cationically-modified siloxane polymers and hydroxyethyl cellulose derivatized with trimethyl ammonium substituted epoxide.

17. The method according to claim 12, wherein at least one nonionic oil in said laundry composition is selected from the group consisting of: polydimethylsiloxane, amino functional silicones, triglyceride oils, silicone polyethers, cyclic polyol esters, cyclic polyol ethers, reduced saccharide esters, reduced saccharide ethers and mineral oils.

18. The method according to claim 12, one or more of the selected cationic polymers in said laundry composition has a molecular weight of less than about 850,000 daltons.

19. The method according to claim 12, wherein said composition is an isotropic detergent-softener composition.
